(19) United States
(12) Patent Application Publication
(10) Pub. No.: US 2003/0126772 A1
(43) Pub. Date: Jul. 10, 2003

(54) Long structural member

(75) Inventors: Nobuyoshi Masumoto, Hirakata-City (JP); Toshio Tanaka, Daito-City (JP); Tatsushi Ito, Hirakata-City (JP); Kaoru Adachi, Hirakata-City (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD, TOKYO (JP)

(21) Appl. No.: 10/336,490

(22) Filed: Jan. 3, 2003

(30) Foreign Application Priority Data
Jan. 4, 2002 (JP) 2002-000133
Aug. 21, 2002 (JP) 2002-240966

(51) Int. Cl. B66C 23/64; B66C 23/683; B66C 23/687; B66C 23/70

(52) U.S. Cl. 37/466; 212/347

(57) ABSTRACT

A member constituting a support-connecting portion with another support structural member is a cast member, and the cast member is integrally built up with a long member formed of a plate material so as to avoid stress concentration. In a long structural member for equipment including a connecting structural portion at a proximal portion, a proximal constitutive portion (6) including a boss (7) and a bracket (8), which are a connecting support portion at the proximal portion, is integrally formed of cast steel. The cast steel proximal constitutive portion (6) is connected and built up with a steel long portion (2) at a connected portion, and thereafter, are integrally welded together.

### CROSS-REFERENCE TO PRIORITY APPLICATION

This application claims the priority of Japanese Patent Application No. 2002-000133 filed Jan. 4, 2002 and Japanese Patent Application No. 2002-240966 filed Aug. 21, 2002 under 35 U.S.C. 119, and the entire contents of both Japanese Patent Application No. 2002-000133 and No. 2002-240966 are incorporated herein by reference.

### BACKGROUND OF THE INVENTION

1. Field of the Invention

The present invention relates to a long structural member for equipment, which is for reinforcing a connecting principal part in long structural members such as an arm or a boom made of a plate material formed with a boss for inserting a pivotally supporting shaft therein at the proximal end.

2. Description of the Background Art

Arms, which are attached to a boom point used in equipment of an excavator to support a shovel, are known. As shown in FIG. 5A, one is an arm 100 having a box-shaped cross-sectional structure. Another known arm is an arm 100A having a rounded triangle-shaped cross-sectional structure as shown in FIG. 5B. The arms 100 (100A) having the above structures are formed with a boss 101 (101a) at the lower portion of the proximal end thereof so that it can be connected to the pivot point portion of a boom (not shown) using a pin. In order to reinforce the surroundings of the boss 101 (101a), a reinforcing plate 102 (102a) is welded to the outer side of the boss. A bracket 104 (104a) is welded and attached to a proximal end 103 (103a) of the arm in order to attach a piston rod (not shown) of a hydraulic cylinder for operating the arm 100 (100A).

The bracket 104 (104a) is welded and attached in the following manner. A plate 105 (105a) closing the end of the arm 100 (100A) having the box-shaped cross-sectional structure (FIG. 5A) or the rounded triangle-shaped cross-sectional structure (FIG. 5B) is welded along the edge of a side plate of the arm. The bracket 104 (104a), that is, the plate material is welded and attached perpendicular to the surface of the welded plate 105 (105a).

The conventional equipment arms 100 (10A) have the structure as described above. For this reason, the equipment arm has the problem that cracks occur in the following portions. More specifically, one portion is the attachment portion of the boss 101 (101a). Another is welded end portions b and c of a member forming the bracket 104 (104a) with respect to the bracket 104 (104a) connecting the arm cylinder rod and the plate 105 (105a) closing the arm end. Another is the termination end d of the plate closing the arm end. The above-mentioned portions are mutually welded and connected, and it is hard to avoid stress concentration. In order to prevent cracks, the following steps are taken; that is, the plate is thickened, and the weld throat thickness is increased, or the weld toe is subjected to grinding. However, this increases the weight of the components.

As described above, the arm 100 (100A) is the welded structure. Thus, the above boss 101 (101a), reinforcing plate 102 (102a) and bracket 104 (104a) are components independent from each other. For this reason, these members are assembled, and thereafter, tack welding and final welding must be carried out; as a result, the number of processes increases. This is a factor of increasing the assembly cost.

Besides, the arm 100A having the rounded triangle-shaped cross-sectional structure shown in FIG. 5B is combined with a conventional boom having a square section, which has been frequently employed. In this case, the bottom side dimension becomes larger as compared with the conventional arm having a square section. For this reason, the outer dimension (boss width) between ends of the boss 101a for connection becomes larger than the end-to-end dimension with a connecting bracket (top bracket) of the boom having a square section. As a result, a problem arises such that the arm and the boom cannot be built up. In order to achieve the build-up, if the boss width of the arm 100A having the rounded triangle-shaped section is made narrow, the width of the bottom side of the triangle section becomes small. For this reason, in the same plate thickness, the section rigidity is reduced; as a result, the arm and the boom are unusable in its strength (i.e., do not have sufficient strength). On the other hand, if the plate thickness is increased, it is impossible to achieve weight reduction, which is the principal purpose of the rounded triangle-shaped section.

In the arm having the rounded triangle-shaped section, if the arm is inverted so that the bottom side can be set upwardly, the above boss width is made small; as a result, the arm can be build up with the boom having a square section. However, the boss receiving excessive stress is arranged on the lower side of the conventional rounded triangle-shaped section. For this reason, the projection of the boss from the side of the arm becomes longer; as a result, the structure becomes further complicated, and it is impossible to practically use these members. Under the condition that the bottom side of the rounded triangle-shaped section is set downwardly, if the built-up width is made large so that the top bracket of the boom having a square section is build up with the boom, the torsion moment applied to the boom top portion becomes larger. For this reason, there is a need of making the section of the top portion large; as a result, the boom design must be fully changed.

In order to achieve weight reduction of the arm having a square section, the following proposal has been presented in place of the conventional structure. That is, the plate material is bent so that a corner can be formed, and the member thus formed is used to reduce welding portions. However, in the connecting structure with respect to the connecting bracket of the boom, many components must be welded as described above. As a result, the number of processes is unchanged in the above connecting structure, and it is difficult to achieve structural weight reduction.

### SUMMARY OF THE INVENTION

The present invention has been proposed in view of the above circumstances. Accordingly, it is an object of the present invention to provide a long structural member for equipments, which can avoid stress concentration by having the following structure. That is, a cast member is used as a part constituting a support connecting part with another support structural member, and a longer member made of a plate material is combined integrally with the cast member.

In order to achieve the above object, according to an aspect of the present invention, there is provided a long structural member for equipments, including a connecting structural member at a proximal portion, comprising:

a proximal constitutive member including a boss and a bracket, which are a connecting support portion at the proximal portion, and which is integrally formed of cast steel; and

a steel long member,

the cast steel proximal constitutive member being integrally welded together with the steel long member (first aspect).

According to the present invention, the proximal member of the arm used as excavator equipment is formed of cast steel, and molded integrally with a structural member including the boss and the bracket, which is a connecting support portion with another member (e.g., boom). The proximal member thus formed is integrally welded together with the point structural member. Therefore, the welded and connected portion is formed without trouble, and thereby, it is possible to prevent local stress concentration generated conventionally. Further, constituent components are integrated, and thereby, workability is enhanced, and time and labor saving is achieved; and therefore, it is possible to solve the conventional problems relevant to strength and manufacturing. As a result, cost reduction can be achieved.

According to the first aspect of the invention, the long structural member has a rounded polygon-shaped section. The proximal portion is provided with a proximal constitutive member including a boss and a bracket, which is formed of cast steel and has a shape adaptable to the shape of the section. The proximal constitutive member is fitted into a welding portion of the steel long member so that these members can be formed integrally with each other by welding (second aspect). By doing so, the proximal constitutive member integrally formed with the boss and bracket for making connection with another member is fitted into the long member connected thereto. Thus, the end portion of the steel member lacking stability in connecting is welded in a state of being secured in its shape by the cast steel member. As a result, the structural members are excellent in workability, and integrally and firmly welded with each other.

According to the first or second aspect of the invention, the long structural member has a rounded triangle-shaped section, and a steel long member has a section such that the bottom side of the triangle is set upwardly. The proximal constitutive portion including the boss and the bracket, is formed of cast steel and has a shape adaptable to the shape of the section of the long portion. The proximal constitutive member is fitted into a connected portion of the point of steel long member so that these members can be formed integrally with each other by welding (third aspect). By doing so, the proximal constitutive portion is integrally formed of cast steel. Therefore, for example, even if the long structural member is-used as the arm for excavator equipment, the width of the connecting boss provided at the proximal portion is, matched with the end-to-end dimension of the top bracket. As a result, the long structural member is usable in combination with the conventional boom having a square-shaped section.

According to the first or second aspect of the invention, the long structural member has a rounded square-shaped section. A long member is formed in a manner that flat U-shaped members having a bent corner in the axial direction in section are vertically arranged to face each other. A plate material is interposed between flange portions of the U-shaped members, and thereafter, is welded in a state that they are abutted against each other. The proximal constitutive member includes the boss and the bracket, which is formed of cast steel and has a shape adaptable to the shape of the section of the long member. The proximal constitutive member is fitted into a connected portion of the steel long member so that these portions can be formed integrally with each other by welding (fourth aspect). By doing so, the proximal constitutive member is integrally formed of cast steel. Therefore, for example, even if the long structural member is used as the arm for excavator equipment, the connecting portion boss provided at the proximal portion is intact connectable with the top bracket of the corresponding boom. In addition, the proximal constitutive member is molded of cast steel; and therefore, the member is molded so as to have a minimum thickness within an allowable range without causing a reduction of strength. As a result, weight reduction is achieved while workability is preferable; and therefore, production cost can be reduced.

According to the third or fourth aspect of the invention, the point portion of the long portion is integrally welded with a point constitutive member including a supporting structure such as a boss, which is a support portion of another connecting member integrally formed of cast steel (fifth aspect). By doing so, it is possible to solve the conventional problem that the boss is manufactured as an independent component, and welded to the point portion of the long member, whereby the strength of the arc welding zone is reduced, and cracking occurs. Further, the number of processes is reduced, and no reinforcement is required; therefore, weight reduction can be achieved.

### BRIEF DESCRIPTION OF THE DRAWINGS

The above and further objects and features of the present invention will become more fully apparent from the following detailed description with reference to the accompanying drawings in which:

FIGS. 1A-1C show an equipment arm according to one embodiment of the present invention, FIG. 1A being a front view; FIG. 1B being a cross-sectional view taken along line 1B-1B of FIG. 1A; and FIG. 1C being an end view taken along line 1C-1C of FIG. 1A;

FIG. 2 is an enlarged sectional view showing principal parts of the arm;

FIGS. 3A-3C show an equipment arm in which the bottom side of a rounded triangle-shaped section is set upwardly, FIG. 3A being a front view; FIG. 3B being a cross-sectional view taken along line 3B-3B of FIG. 3A; and FIG. 3C being a right side view;

FIGS. 4A and 4B show an equipment arm having a rounded square-shaped section, FIG. 4A being a perspective view showing the entire structure; and FIG. 4B being a cross-sectional view taken along line 4B-4B of FIG. 4A; and

FIGS. 5A and 5B are perspective views showing the entire structure of conventional equipment arms, FIG. 5A showing an arm having a square cross-sectional structure; and FIG. 5B showing an arm having a square cross-sectional structure.

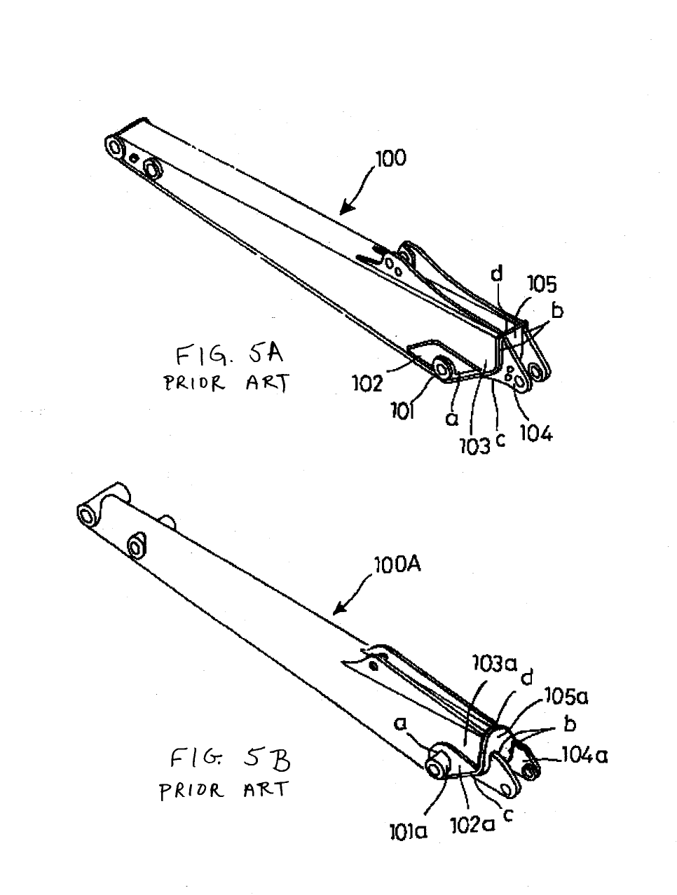

### DETAILED DESCRIPTION OF THE PREFERRED EMBODIMENT

Preferred embodiments of the long structural member according to the present invention will be described below with reference to the accompanying drawings.

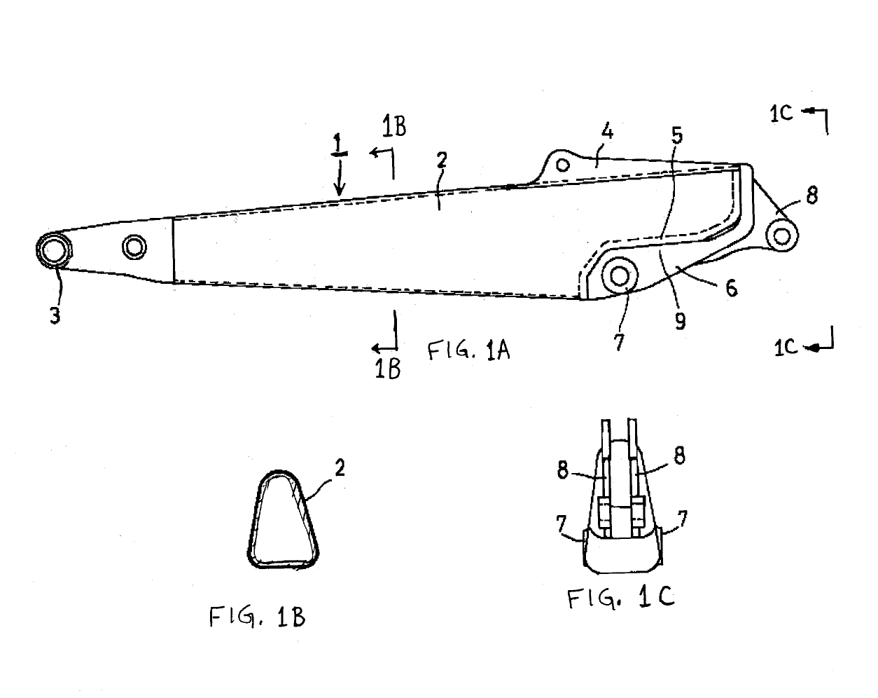

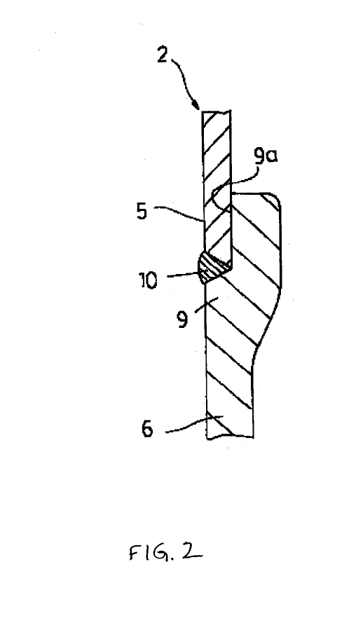

FIGS. 1A-1C show an equipment arm according to one embodiment of the present invention, FIG. 1A being a front view; FIG. 1B being a cross-sectional view taken along line 1B-1B of FIG. 1A; and FIG. 1C being an end view taken along line 1C-1C of FIG. 1A. FIG. 2 is an enlarged sectional view showing principal parts of the arm.

A long structural member 1 of the embodiment is applied to an arm used for excavator equipment. The long structural member 1 (hereinafter, referred to as “arm 1”) has a cross section shown in FIG. 1B. The arm is formed of a steel plate so as to have a rounded triangle-shaped section (each vertex portion of the triangle is formed into an arc). A proximal constitutive member 6 is formed of cast steel so that it can be formed integrally with a long portion 2 forming the arm. The long portion 2 is jointed (connected) integrally with the proximal constitutive member 6 by welding.

The long member 2 of the arm 1 is formed with a boss 3, which is attached with attachments such as a bucket, at the point thereof. The rear portion of the long portion 2 has an opening edge 5, which is opened from the lower half to the rear end so that it can be connected with the above-mentioned proximal constitutive portion 6. Thus, the long portion 2 is formed so as to have a rounded triangle-shaped section and a desired length. The rear portion of the long portion 2 is additionally provided with an attachment bracket 4 for a steel attachment-operating cylinder at the upper side.

The proximal constitutive portion 6 is formed into a shape covering the opening of the rear portion in the long portion 2. A boss 7 for making connection with the boom is formed perpendicular to the axial line of the arm at the front position of the proximal constitutive portion 6. A bracket 8 for connecting an arm operating cylinder rod is provided at the outer end of the rear portion of the proximal constitutive portion 6. The above boss 7 and bracket 8 are arranged forkedly and in parallel with each other. A welding edge portion 9 with the rear opening edge 5 of the long portion 2 is formed with a fitting step portion 9a shown in FIG. 2 so as to match with the shape of connected portion.

The above long portion 2 and proximal constitutive portion 6 are integrally connected to each other in the following manner. That is, the connected edge portion 9 of the cast proximal constitutive portion 6 is fitted into the rear opening edge 5 of the steel long portion 2 having a desired shape and dimension along the step portion 9a formed in the welding edge portion 9. Thereafter, the connected edge portion 9 and the rear opening edge 5 are kept at the connected state and integrally connected together. Therefore, a connected portion 10 of the long portion 2 with the proximal constitutive portion 6 is welded over the entire circumference.

As described above, different two members (long portion 2 and proximal constitutive portion 6) are built up so as to form the arm 1. In this case, one of two portions, that is, the long portion 2 is a member formed by bending a steel plate; the other, that is, the proximal constitutive portion 6 is molded of cast metal material. Therefore, the rear opening edge 5 of the steel long portion 2 is fitted into the connected edge portion 9 of the cast proximal constitutive portion 6 along the step portion 9a, and they are partially welded together by tack welding. By doing so, even if the rear opening edge 5 is formed into an irregular shape, the shape of the opening edge 5 can be securely kept and correctly connected.

Since the arm 1 thus built up has the proximal portion formed of a casting as described above, even if an external force is applied thereto during use, no stress concentration locally occurs. Therefore, the arm 1 is durable for a long period of use without causing cracking. In addition, the part usually requiring many processes is integrally formed, and thereby, the number of components can be reduced to the minimum, and the number of processes is reduced, so that cost reduction can be achieved.

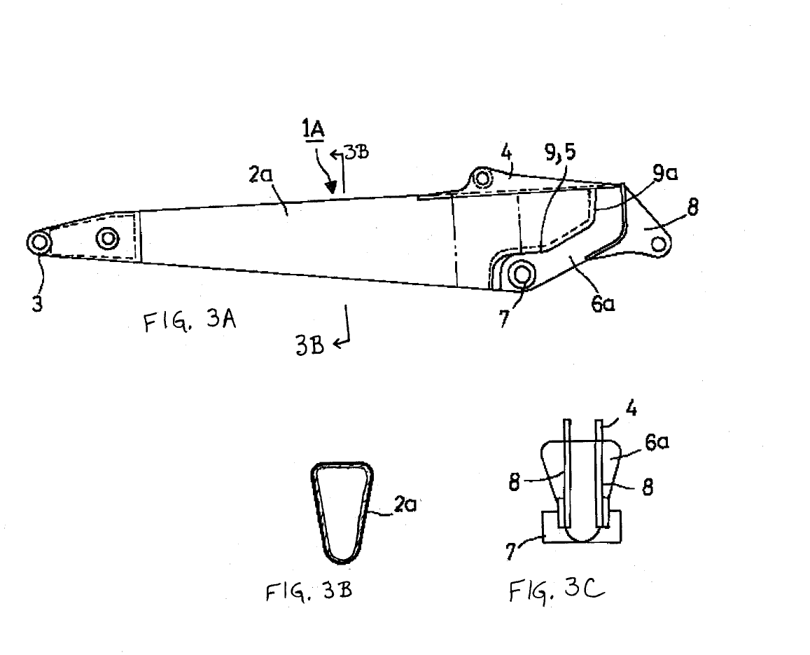

FIGS. 3A-3C show another embodiment of an equipment arm in which the bottom (flat) side of a rounded triangle-shaped section is set upwardly, FIG. 3A being a front view; FIG. 3B being a cross-sectional view taken along line 3B-3B of FIG. 3A; and FIG. 3C being a right side view.

The arm of FIGS. 3A-3C is basically the same as that of the above-described embodiment, and differs in that the cross-sectional shape of the long portion is formed reverse to the above-described arm. Therefore, common reference numerals are used to designate the portions which are the same as or identical to those of the above-described embodiment.

In the arm 1A shown in FIG. 3A, a long portion 2a is formed of a steel plate so as to have a rounded triangle-shaped section and a desired length, and a proximal constitutive portion 6a is formed of cast steel so as to have a desired shape. Like the above-described embodiment, the proximal constitutive member 6a is fitted into the rear opening edge 5 of the long portion 2a along a step 9a formed in the connected edge portion 9 of the proximal constitutive portion 6a. Thereafter, the rear opening edge 5 and the connected edge portion 9 of the proximal constitutive portion 6a is integrally connected by welding.

In the embodiment of FIGS. 3A-3C, the section has a so-called inverse triangle shape. However, in this case, the connecting boss 7 is integrally molded as the proximal constitutive portion, so that the boss 7 can be formed with the same width as the conventional type. Therefore, the arm 1A can be used in combination with the already existing boom (not shown).

Further, in the embodiment of FIGS. 3A-3C, when using the arm 1A, excessive stress is applied to the boss 7, and the vertex portion of the rounded triangle-shaped section of the arm 1A is positioned as the bottom side. In this case, since the arm 1A has a cast integral structure, the base portion of the boss is made into a curved surface. In this manner, it is possible to arbitrarily select the reinforcing shape durable to the load. Therefore, the arm 1A has a stable structure against the load, and has durability.

The above embodiments have described the long structural member having a rounded triangle-shaped section. Alternatively, a square or polygon-shaped or other shaped section may be employed.

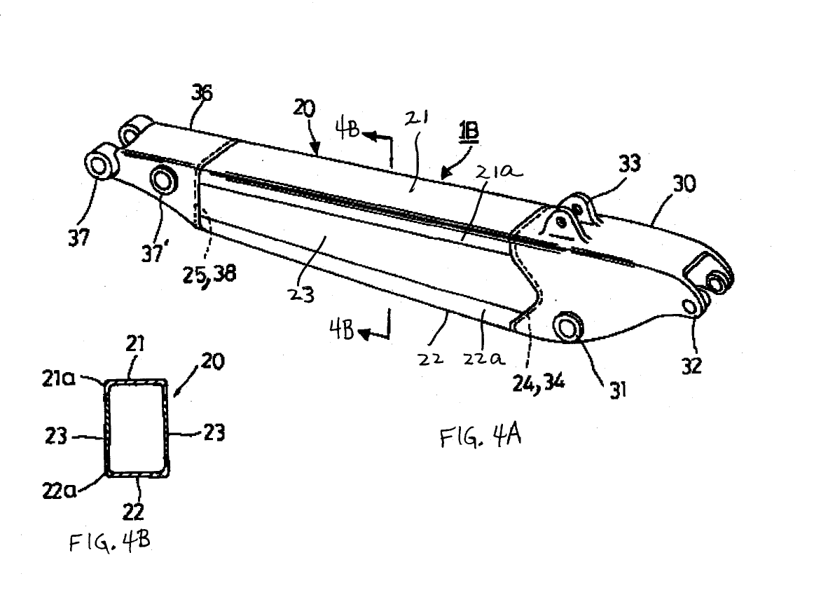

FIGS. 4A and 4B show an equipment arm having a rounded square-shaped section, FIG. 4A being a perspective view showing the entire structure; and FIG. 4B being a cross-sectional view taken along line 4B-4B of FIG. 4A.

An arm 1B of the embodiment has a rounded square-shaped cross-sectional structure configured in the following manner. That is, a steel long portion 20, a cast proximal constitutive portion 30 like the above embodiment and a point constitutive portion 36 are integrally connected by welding.

As shown in FIG. 4B, the long member 20 comprises upper and lower members 21 and 22, which have a desired length and which are formed into a flat U-letter shape with arc-shaped corners, and steel side plates 23 cut into a desired length. The long member 20 is assembled in the following manner so as to have a rounded square-shaped section and the desired external shape and length. That is, the upper and lower members 21 and 22 vertically face each other with a desired spacing therebetween. The side plates 23 are interposed between mutually facing flange portions 21a and 22a, which perpendicularly bend from the flat portion of the upper and lower members 21 and 22 in the widthwise direction of the section. The side plates 23 are welded to flange portions 21a and 22a in a state of being abutted against the end faces of them.

The proximal constitutive portion 30 is formed into a shape covering the rear-opening portion of the long portion 20. A boss 31 for making connection with the boom is formed perpendicular to the axial line of the arm 1B at the front side position of the proximal constitutive member 30. A bracket 8 for connecting an arm operating cylinder rod is provided at the rear end of the rear portion of the proximal constitutive member 30. The above boss 31 and bracket 32 are arranged forkedly and in parallel with each other. Further, proximal constitutive member 30 is formed integrally with an attachment bracket 33 for attachment to an operating cylinder on the upper surface of the front portion. A connected edge portion 34 with the rear opening edge portion 24 of the long portion 20 is formed with a fitting step portion so as to match with the welding shape, like the above-described embodiment. The rear-opening portion 24 of the long member 20 is fitted into the welding edge portion 34 along the step portion, and thereafter, is welded and connected (see FIG. 2).

The point constitutive portion 36 is formed integrally with boss portion 37 for attachments such as bucket and a link attachment boss portion 37′ so that the bosses can be perpendicular to the axial line, at the distal end. The above bosses are formed of cast steel to have a desired outer dimension. A rear welding edge portion 38 is formed with a step portion like the welding edge portion 34 of the above proximal constitutive portion 30. A front edge 25 of the long portion 20 is fitted into the rear connected edge portion 38 along the formed step portion, and thereby, the point constitutive portion 36 is welded and connected together with the long portion 20.

The equipment arm 1B having the above-described structure has a rounded square-shaped cross-sectional structure. Further, in the intermediate member, that is, the long portion 20, the point and proximal sides having complicated shape are molded of cast steel. Thus, these cast steel moldings are made thin within an allowable range, and thereby, it is possible to eliminate a portion requiring complicated welding. Therefore, workability is preferably improved, and the strength is also enhanced; and as a result, weight reduction can be achieved. In addition, the complicated structure components are formed by molding; and therefore, the external appearance is beautifully finished. In the arm 1B (long structural member) having the rounded square-shaped cross-sectional structure, the upper and lower members 21 and 22 constituting the long member 20 are formed by bending a steel plate. Besides, rolled steel having a thick round portion is used, and thereby, the sectional strength is improved; and as a result, the entire strength can be also improved.

In the above arms 1 and 1A having the rounded triangle-shaped cross-sectional structure, the point constitutive portion may be formed like the above arm 1B having the rounded square-shaped cross-sectional structure. That is, a steel member is welded integrally with the point portion of the long portion 2; 2a, although is not illustrated. By doing so, the same effect as in the above embodiment can be obtained.

According to the present invention, in the equipment arm, the long structural portion is movably attached in built up form with another member (e.g., a boom). That is, in order to improve the strength of member, the cast steel combined connecting portion receiving a large load member is integrally welded together with the longer formed steel member. By doing so, it is possible to solve the conventional problems relevant to strength and manufacture. The arm having the rounded triangle-shaped cross-sectional structure is built up with the boom having a square section widely employed conventionally in excavator equipments, and thereby, a weight reduction of the equipment can be achieved. Therefore, it is possible to reduce the weight of a counter weight, or to realize improvement of manufacturing cost. Of course, in arms having the rounded square-shaped cross-sectional structure, the strength can be improved, and weight reduction can be achieved.

In the above embodiments, the equipment arm has been described. The present invention is not limited to the arm for the above-mentioned excavator equipment, and is applicable to long structural members including the connecting portion employed in other machines. Of course, the above modifications belong within the scope of the present invention as defined in the appended claims.

What is claimed is:

1. A long structural member for equipment, including a connecting structural portion at a proximal portion, comprising:
a proximal constitutive portion including a boss and a bracket, which are a connecting support portion at the proximal portion, and integrally formed of cast steel; and
a steel long portion,
the cast steel proximal constitutive portion being integrally welded together with the steel long portion.

2. A long structural member for equipment according to claim 1, wherein the long structural member has a rounded polygon-shaped section, the proximal portion is provided with said proximal constitutive portion including a boss and a bracket, which is formed of cast steel and has a shape adaptable to the shape of the section, and the proximal constitutive portion is fitted into a connected portion of the steel long member so that these members can be formed integrally with each other by welding.

3. A long structural member for equipment according to claim 2, wherein the long structural member has a rounded triangle-shaped section, a steel long portion has a section such that the bottom side of the triangle is set upwardly, the proximal constitutive portion including the boss and the bracket, which is formed of cast steel and has a shape adaptable to the shape of the section of the long portion, and the proximal constitutive portion is fitted into a connected portion of the steel long portion so that these members can be formed integrally with each other by welding.

4. A long structural member for equipment according to claim 3, wherein the point portion of the long portion is integrally welded with a point constitutive portion including a supporting structure such as a boss, which is a support portion of another connecting member integrally formed of cast steel.

5. A long structural member for equipment according to claim 2, wherein the long structural member has a rounded square-shaped section, a long member is formed in a manner that flat U-shaped members having a bent corner in the axial direction in section are vertically arranged to face each other, a plate material is interposed between flange portions of the U-shaped members, thereafter, is welded in a state that they are abutted against each other, the proximal constitutive portion including the boss and the bracket, which is formed of cast steel and has a shape adaptable to the shape of the section of the long member, and the proximal constitutive portion is fitted into a connected portion of the steel long portion so that these members can be formed integrally with each other by welding.

6. A long structural member for equipment according to claim 5, wherein the point portion of the long portion is integrally welded with a point constitutive portion including a supporting structure such as a boss, which is a support portion of another connecting member integrally formed of cast steel.
